(19) United States
(12) Patent Application Publication
(10) Pub. No.: US 2016/0055587 A1
(43) Pub. Date: Feb. 25, 2016

(54) Method that forms investment strategy to invest and withdraw a company's stock or fund

(71) Applicant: Manuel Chau, Macau (MO)

(72) Inventor: Manuel Chau, Macau (MO)

(21) Appl. No.: 14/804,359

(22) Filed: Jul. 21, 2015

(51) Int. Cl. G06Q 40/06; G06Q 40/04

(52) U.S. Cl. CPC G06Q 40/06; G06Q 40/04

(57) ABSTRACT

My invention is a method that forms an investment strategy to invest and withdraw, by using crossover of 2 moving average from data of leading economic indicators to determine buy and sell signals for company's stocks or funds. The researcher set 2 moving averages from data of leading economic indicators, the faster moving average and the slower moving average. When the faster moving average moves above the slower moving average, it signals the investor to buy and hold the stock/fund, and vice versa. To refine this investment strategy to invest and withdraw, backtesting is used to test the historic company's stock/fund's price movement with different combinations of moving averages stated in the above method.

### BACKGROUND OF THE INVENTION

In the past, investors formulates buy and sell signals based mainly on technical analysis, which is by stock market's past prices and volume. Here technical analysis refers to the forecast of investment's future price trends by past prices and trading volume instead of the investment's intrinsic value. This is based on technical analyst believes that the historical performance of investment's prices and volume are indications of its future price trends.

So, these investment strategies, based on technical buying and selling signals, usually cannot capture the changes in economic cycles or conditions. Leading economic indicators enable investors to understand and predict economic cycles. Since stock-market movements are related to economic cycles and conditions, leading economic indicators are also, to a certain extent, predictable to stock-market movements. But there are many uncertainties in using these leading economic indicators to determine buying and selling signals of stocks/funds. And little research is done on how to solve these uncertainties and develop investment strategies.

To understand my invention, let me please explain leading economic indicators, moving average, and the concept of backtesting.

Leading economic indicators, by definition, usually refers to an economic variable that usually change before the changes of the economy of an area. When I apply in my researches, it may cover a much smaller range than the entire economy. It may be an economic variable that change before the changes of only a particular business sector. In other words, Leading economic indicators' movements may signals changes of future conditions of the economy of the area or only, as small as, a particular business sector. In US, one of the most well-known leading economic indicators is the Conference Board Leading Economic Index (LEI). The LEI is made up of 10 components that signals future changes of the economy, such as the Manufacturers' new orders for nondefense capital goods excluding aircraft orders, Stock prices for 500 common stocks, and Average consumer expectations for business conditions etc. (conference-board.org, 2015). Here, leading economic indicator covers more than only the LEI, or its components. Other leading economic indicators are also used as long as they showed predictability in movements of stock/fund prices, such as the personal consumption expenditures (PCE) in the United States (US). Since personal consumption expenditures accounts around 70% of economic activities in the US, its change may predict the future direction of the US economy. It also signals the changes in the US business environment, and is able to predict lots of US listed companies' revenue/profit, and future trends of the stock market (Ellis 2005). In other regions, a leading economic indicator may be, the manufacturing and non-manufacturing monthly purchasing managers' Indices (PMI). Such as in China, China's official PMI showed predictability in the movement of stock market in China, and Hong Kong (Wang 2009).

As discussed above, leading economic indicators may represent a much smaller range, as small as only a business sector. So, leading economic indicators cover a much broader scope than only a few macro-economic data we usually think about. In my research, I may use Baltic Dry Index (BDI) to test the performance of raw material producers stocks, export and import statistics to test the performance of shipping companies' stocks. Sometimes, stock market index may be a leading indicator of stocks price of some business sectors. For example, the NASDAQ index, which reflects a number of US hi-tech companies' stocks prices, shows predictability for a number of Asian/Taiwan hi-tech hardware manufacturers' stock price. When the NASDAQ index maintain in a high level, it signals prosperous business environment for the hi-tech business sector and is a good leading signal to their suppliers. Market trading volumes may also be a leading economic indicator for stocks price of certain business sectors. For example, in the times when the total trading volumes of S&P 500 companies maintain high, it may indicate a prosperous business environment for US financial stock broker companies and asset management companies, which benefit from more commission revenues. In this document, I will show an example to test the stock performance of a listed US stock broker with the total trading volumes for S&P 500 companies, which showed outstanding results for a backtest for around 15 years.

In the process of predicting the stock market movements with any leading economic indicator, two important existing problems are the uncertainty in accuracy of prediction, and uncertainty for how long to happen. That is, how high is the possibility, and how long, will the changes in the leading economic indicator result in changes in the stock market? It may have uncertain answers, such as, If the change in leading economic indicator happens now, it is likely/highly possible that the changes in stock market will happen in, maybe in 1 month, or maybe 2 months, or maybe within several months. These uncertain answers give uncertain buying and selling signals for investors.

Frequency and time lag to release these economic data is also important for conducting the test. Some economic indicator are not able to put into use for prediction due these data are released less frequently and with long time lag. One example of this is Quarterly GDP, which is released 4 times only a year, and may take 1 or 2 months' time lag to release after the end of each quarter. Investors preferred promptly and frequently released data to benchmark their investments. And if data is released daily or even real time, such as S&P500 trading volumes or BDI, tests may be conducted with more flexibility on their time intervals.

Unlike leading economic indicator discussed above, coincident indicators are economic indicators that reflect the conditions nearly at the same time they signify. Lagging indicators are economic indicators that change after the economy as a whole changes. Since coincident and lagging indicators are seldom ahead of the stock market changes, they are rarely used to predict stock market's movements (Ellis 2005)

To confirm whether an economic indicator's movement is considered leading, or ahead of, the company's stock price or stock market index movement, computer statistic testing software or econometric models are usually used, such as the Vector auto regression or known as VAR (Wang 2009). Another simple method that I would recommend is to make a year over year (yoy) basis chart for the economic indicator and the stock price/stock market index movement. Year over year basis chart assist to reduce the volatile characteristic of the data in absolute basis. Therefore, year over year basis charts allow researcher to make visual comparisons for which data is leading, or ahead in time. Mr. Ellis, Joseph H, in his book Ahead of the Curve published in 2005, known this method as rate of change in economic tracking. I recommend this method because it allows researcher to easily check whether any tested data is leading or not and confirm its consistency in the early stage of research. This is important because it allows researcher to sort out unimportant data and reduce a lot of further work required in the test. This method is also easily understandable by anyone who is not familiar with econometric models or software. For some economic data that is already seasonally adjusted by other computer statistics software, may not require this year over year basis adjustments, such as PMI data (Ellis 2005).

Moving average is the mean of time series data from several consecutive periods. It is continually recomputed by adding the latest value and dropping the earliest value.

One technique commonly used by technical analysis to show buying and selling signals is the crossovers for multiple moving averages of historic company's stock price or stock market index movement. Technical analysis usually set multiple, or at least 2, moving averages based on historic stock market index or stock price movement. They usually set a faster moving average that made by a shorter period of time series data, and a slower moving average that made by longer period of time series data. When the faster moving average is over the slower moving average, it is considered an upward trend and considered as buying signal, vice versa. This technique is usually known as moving average crossovers by technical analysis (Casey 2015; Moving Average Crossovers 2015).

By this technique, different moving average may be used, such as simple moving average (SMA), exponential moving average (EMA), and linear weighted moving average (WMA). Simple moving average (SMA) is the un-weighted mean of a certain period of time. Exponential moving average (EMA) is a weighted mean that data are exponentially weighted and more weight is given to the latest data. The calculation for Exponential moving average (EMA) is shown as below:

Current EMA=((Price(current)−previous EMA))×multiplier)+previous EMA.

Where the multiplier=2/(1+number of period)

Linear weighted moving average (WMA) is a moving average that data are linearly weighted over certain period of time, which the oldest value receive the least weight and the latest value receive the highest weight. The calculation is the oldest value is given the multiplier (or weight) of 1, the second oldest given weight of 2, and third oldest value weighted 3, and so on until the latest value is reached and given its weight. After all, these numbers is added together and divided by the sum of all these multipliers. In the crossover of moving average technique, when more crossovers is required, EMA and WMA is more suitable than the SMA (Twomey 2015).

Backtesting is the process of testing an invest and withdraw strategy based on data from previous time periods to improve the strategy's accuracy. Instead of applying the strategy for the time period forward, backtesting enable the researcher to save years of time for gathering data by making simulations on his strategy based on past data. Backtesting emphasis on checking the logic in strategies, it sometimes omit part of the details if it is believed not important, such as transaction cost and/or dividends income (Backtesting 2015).

### DETAILED DESCRIPTION OF THE INVENTION

My invention is a method that use crossover of 2 moving average with data of leading economic indicators to determine buy and sell signals for company's stocks or funds. As discussed in the part of the background of the invention, leading economic indicators may be a signal that represents a much smaller range than the entire economy. So it covers a much broader scope than only a few macro-economic data we usually think about. The researcher set 2 moving averages. The faster moving average, which has shorter time intervals, is more sensitive to changes in economic trends. The slower moving average, which have longer time intervals, is less sensitive to changes in economic trends. When the faster moving average moves above the slower moving average, it shows the economic trends are going upwards and signals the investor to buy and hold the stock/fund. On the other hand, when the faster moving average moves below the slower moving average, it signals economic trends are going downwards and signals the investor to sell or exit the stock/fund. This forms an investment strategy to invest and withdraw from the company's stocks or funds.

To refine the investment strategy for investing the stock/fund, backtesting is used to test the historic company's stock/fund's price movement with different combinations of moving averages stated in the above method. This invention aimed to overcome the uncertainty of predicting the stock market movements with leading economic indicator, and assist investor to develop strategy to capture stock market movements due to economic changes.

To apply in use, I would recommend a 4 step method; some of them required the input from the researcher.

Step 1. Define an investment target, which may be company's stock or fund that researcher wants to determine buy and sell signals and form investment strategy.

Step 2. Identify the right leading economic indicators of the target. List a number of possible leading economic indicators that the researcher believes may be able to predict the future movements of the target defined in step 1. The researcher may need to adjust the time lag according to the release time of that economic data that the researcher is able to use. For example, China Official monthly PMI will be released on the next day morning after that month. That is, the researcher may use January's monthly PMI data on the morning of 1^{st} of February. If a researcher is using this monthly data, he will adjust this data's time frame to +1 month.

To confirm whether an economic indicator's movement is leading, or ahead of, the target defined in step 1, the researcher have to test it. The researcher may use computer software or econometric models to test it. Or researcher may make a year over year change basis (yoy) chart for both the target's movement and the economic indicator to make visual comparisons, including time lag discussed above. At this step, the researcher has to confirm at least one, or more than one, economic indicator that is leading, or ahead of, the target's movement. This confirmed leading economic indicator will proceed for the next step. If researcher confirms there are no leading economic indicator of the target in this step, researcher will have to re-do the whole Step 2 again to list, to test, and to identify the right leading economic indicators of the target.

Sometimes, the researcher may also use a weighted average of these economic indicators if it is believed to improve the accuracy of prediction of target's movement.

Step 3. The researcher has to backtest the historic data of investment target (defined in step 1) with 2 moving averages from data of economic indicators with different leading economic indicator confirmed in step 2, at a fixed capital. SMA, EMA, WMA or other moving averages may be used. The backtest will start at a fixed initial capital, lets say $1000, and will compare the investment performance in the test. The researcher has to set 2 moving averages, a faster moving average and a slower moving average for the leading economic indicator confirmed in step 2. The buy and sell signals of the target is generated by the crossing of these moving averages. When the faster moving average moves above the slower moving average, it is seen that the economic trend is upwards. It signals buying or holding the target that period. On the other hand, when the faster moving average moves below the slower moving average, it is seen the economic trend is downwards, and signal selling or not buying the target for that period. Each faster moving average will test against each slower moving average.

In this step, researcher has to backtest the leading economic indicators confirmed in step 2 each at a time. That is, if the researcher confirmed 3 leading economic indicators in step 2, the researcher may need to backtest the target's movement with each of these 3 leading economic indicators.

Step 4: Evaluate the results across different combinations of moving averages and different leading economic indicators. The pair with highest return is the most likely to show best combinations that gives the most accurate buy and sell signals in the test. Or in other words, it is the combination that forms the best investment strategy. However, researcher also needs to analyze and check whether it is consistent in:
Avoiding a huge drop, or showing a selling signal before a price collapse.
Capturing a long term rise, showing a buying signal before price is going to rise.
Check also the MA combinations that is next to or close to the one with best results. If those combinations are also showing above average results, researcher may believe investment profit will also be above average in the future.

If the results in this step are satisfactory, researcher may set it as a future investment strategy in investing the target. If the results are not satisfactory, or researcher believes adjustments or modifications are able to improve the results, researcher will need to go back to Step 2 again.

To illustrate the invention, I will show 3 examples here. The first example is to develop an investment strategy for the stock price for Wynn Macau Limited, which is listed in Hong Kong Stock exchange under the code of 1128.hk.

Step 1, the stock price movement of Wynn Macau Limited is set as the target.

Step 2. Since Wynn Macau Limited operated in Macau and its stock price should highly dependent to economic conditions of Macau and also the Greater China region, I believe the below economic indicators may predict it stock price movements. Time lag adjusted due to time required to release data.

Monthly tourist entry into Macau (+1 month) yoy change

Macau monthly gaming revenue (+1 month) yoy change,

Macau monthly M2 (+2 month) yoy change,

Macau monthly loans issued by banks (+2 months) yoy change,

China Official Manufacturing PMI (+1 month)

China Official Non-Manufacturing PMI (+1 month)

To confirm whether these economic indicators are ahead the target's movement or not, year over year change basis charts are made by the target's movement with each of the economic indicator for researcher's visual comparisons. These charts are shown in FIG. 1 to FIG. 6. FIG. 7 is the summary of the results of the visual comparisons.

Comparing these charts, the leading economic indicators are the China's official manufacturing PMI (ahead around −1 to 2 month of target's movement by visual comparison), and the China's official non-manufacturing PMI (ahead around 1 to 3 month of target's movement by visual comparison). To improve the results, in terms of accuracy, and stability for time to happen, I take an weighted average of China's official manufacturing PMI (weighted 40%), and the China's official non-manufacturing PMI (weighted 60%). This 40% to 60% ratio is similar to the current composition of manufacturing and non-manufacturing activities in current Chinese economy. I reconfirmed this again in the chart in FIG. 8, this weighted index is stably ahead for 0 to 2 months. This is marked in FIG. 9, which I believe this weighted average index will show satisfactory results in further steps.

Step 3. Prepare different combinations faster and slower moving averages for the confirmed weighted index in step 2. I backtest these combinations with the historic prices of Wynn Macau Limited. When the faster moving average of the weighted index moves above its slower moving average, signal buying or holding the shares of Wynn Macau Limited for that month. And when the faster moving average of the weighted index moves below its slower moving average, signal selling or not to buy.

Step 4: Evaluate the investment results with different combinations of moving average of the weighted index. The results are shown in FIG. 10. One of the best combinations is using the index that month as the faster moving average, and EMA 3 month of the index as the slower moving average. (I refer this expression as 1 month/EMA3). Here, refer to FIG. 11, the investment result for this pair of faster and slower moving average, made total result of 4,221.03 in around 5 years' time. Its Return on investment (ROI), which is the return of an investment divided by the initial investment will be 322%. While normal buy and hold strategy made ROI 33.6%. The other combination next to this considered best pair, the 1 month/EMA2 and 1 month/EMA4, also showed above average results.

The second example is to develop an investment strategy to invest or withdraw an ETF of the S&P500 listed under the code of SPY.US. This example is designed to test whether the invention is able to develop strategy over any stock market index, and the ETF is used as a medium for this test. In Step 2, I tested a number of economic indicators and finally found satisfactory results on an weighted average of:
1. ISM Manufacturing: New Orders Index (NAPMNOI)+1 month weighted 20%
2. ISM Non-manufacturing: New Orders Index (NMFNOI)+2 month weighted 80%

This ratio, again, is similar to the current composition of manufacturing and non-manufacturing activities in current US economy. Non-manufacturing activities compose of a majority in the economy, while manufacturing activities accounts less than 20% of current US GDP. For time adjustments, NAPMNOI is usually released on the next day after each month, which is possible for +1 month time lag. And NMFNOI is released 5 days after each month, so making the backtest only possible to use with +2 month time lag.

In step 3, I backtested different combinations for the faster and slower moving averages. And in step 4, shown in FIG. 13, one of the best combinations is the 1 month/EMA 4. FIG. 14 showed this strategy made ROI 92% in around 15 years' time, while normal buy and hold strategy made only 43%. The other combination that I would recommend is 1 month/WMA5 and 1 month/EMA10, which the combinations next to it also show above average results.

My suggestion for this result is S&P 500 is a sensitive index and being quite leading to the economy. My method here enables researcher easily locate that that the weighted average of New Orders Index from ISM manufacturing and non-manufacturing is a good indicator of the S&P 500. Also the method refined by backtest and will improve future investment performance.

The third example is to develop investment strategy to invest or withdraw the TD Ameritrade Holding Corporation, which is mainly a stock broker, listed in the NYSE under the quote of AMTD. In Step 2, I found a leading economic indicator is simply the monthly total trading volumes of the companies in S&P 500 yoy change (+1 month), which is an easy obtainable data that show the business conditions of the sector of stock broker companies. In step 3, I backtested different combinations for the faster and slower moving averages of this indicator. And in step 4, shown in FIG. 15, one of the best combination is using the combination 1 month/SMA5. FIG. 16 showed this combination made 3428% ROI in around 15 years' time. The second best combination is the EMA2/EMA3, which also make ROI 3095%. Here, the other combinations next to EMA2/EMA3 show better results than the combinations next to 1 month/SMA5. So the researcher may take EMA2/EMA3 instead. My suggestion for this result is the monthly total trading volumes of the companies in S&P 500 is an effective leading economic indicator for predicting the stock prices of AMTD and a number of listed US stock broker companies. And investment results are outstanding over a backtest of around 15 years.

### BRIEF DESCRIPTION OF THE DRAWINGS

FIG. 1 is a chart for visual comparison of Wynn Macau Limited stock price yoy change (scale on left) compared to Monthly tourist entry into Macau (+1 month) yoy change (scale on right). The chart does not show strong correlation between the 2 data in terms of which data is leading.

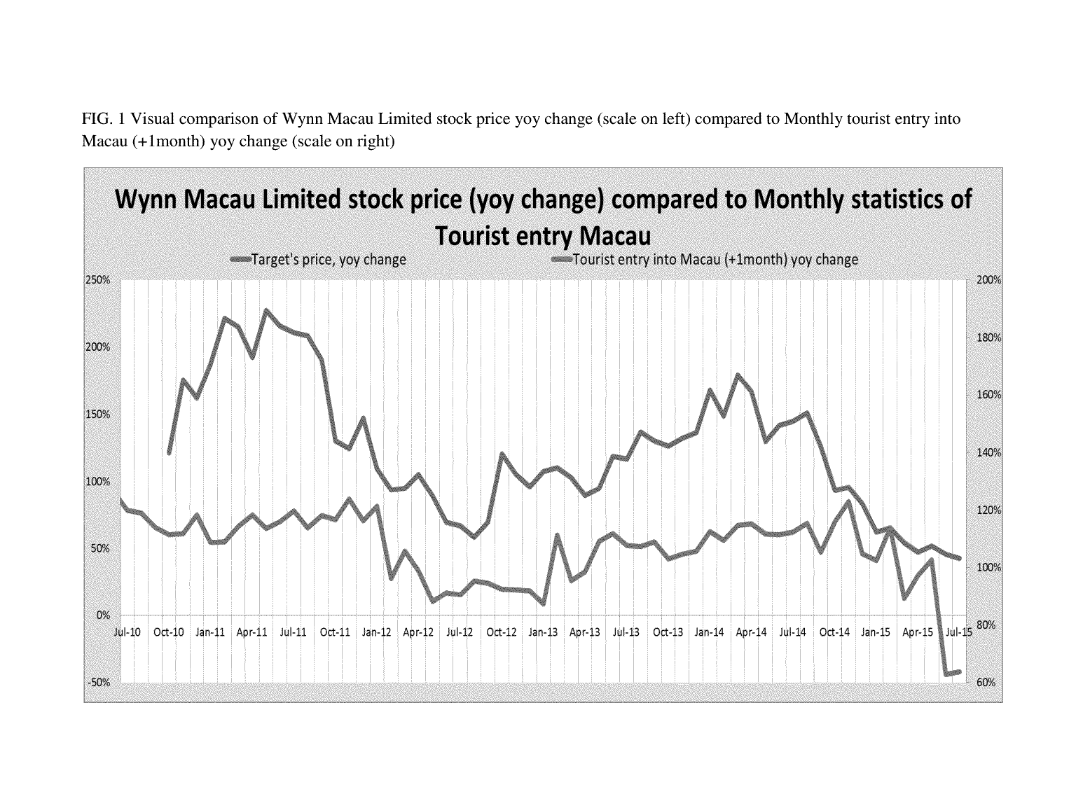

FIG. 2 is a chart for visual comparison of Wynn Macau Limited stock price yoy change (scale on left) compared to Macau monthly gaming revenue (+1 month) yoy change (scale on right). The chart shows the economic indicator is a coincident indicator that most changes happen at nearly at the same time with the target.

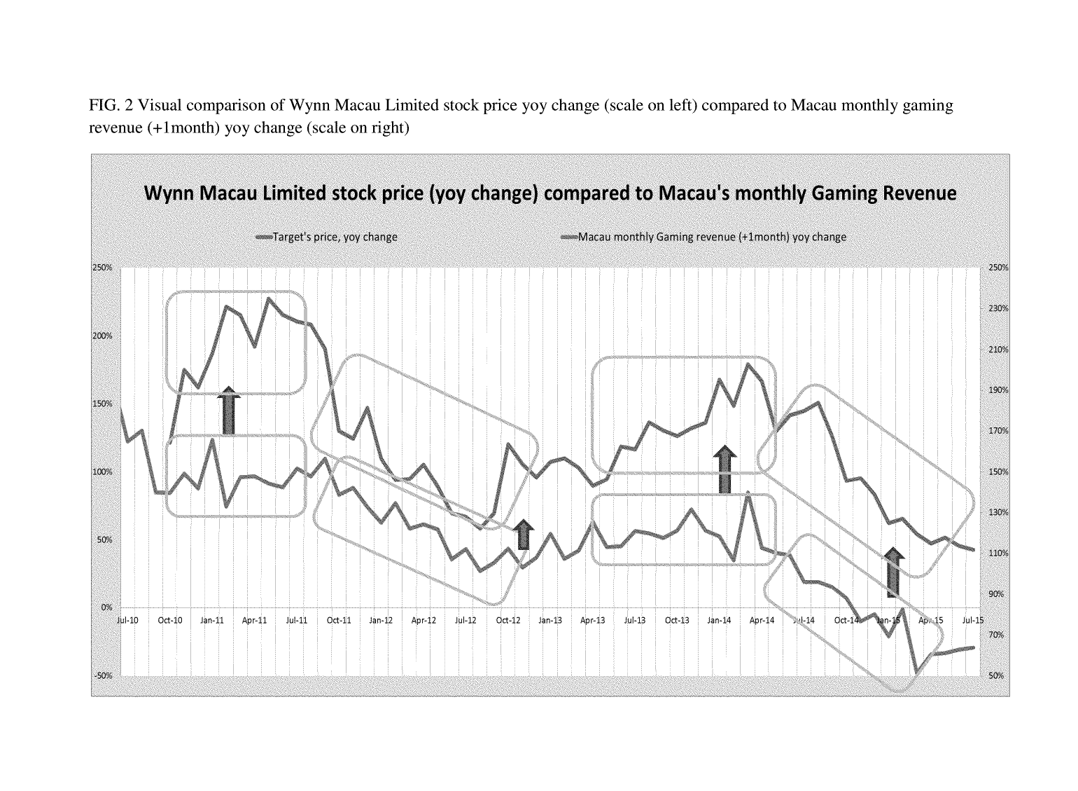

FIG. 3 is a chart for visual comparison of Wynn Macau Limited stock price yoy change (scale on left) compared to Macau monthly M2 (+2 month) yoy change (scale on right). The chart shows the economic indicator is a lagging indicator for the target as most changes happened after the target changes.

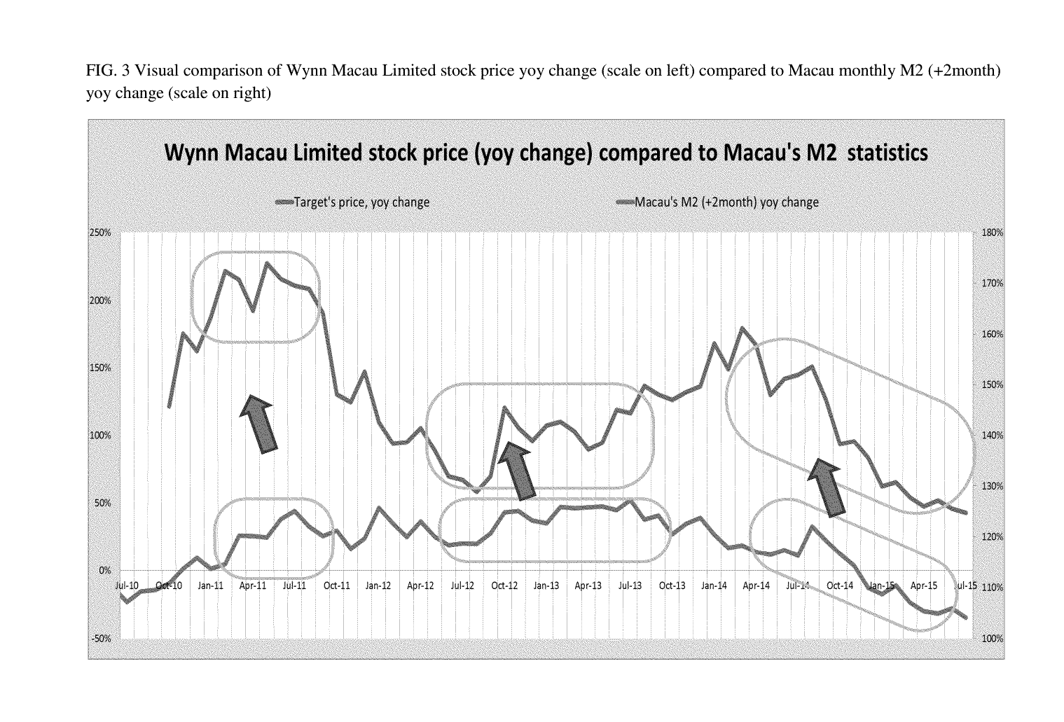

FIG. 4 is a chart for visual comparison of Wynn Macau Limited stock price yoy change (scale on left) compared to Macau monthly loans issued by banks (+2 months) yoy change (scale on right). The chart shows the economic indicator is a lagging indicator for the target.

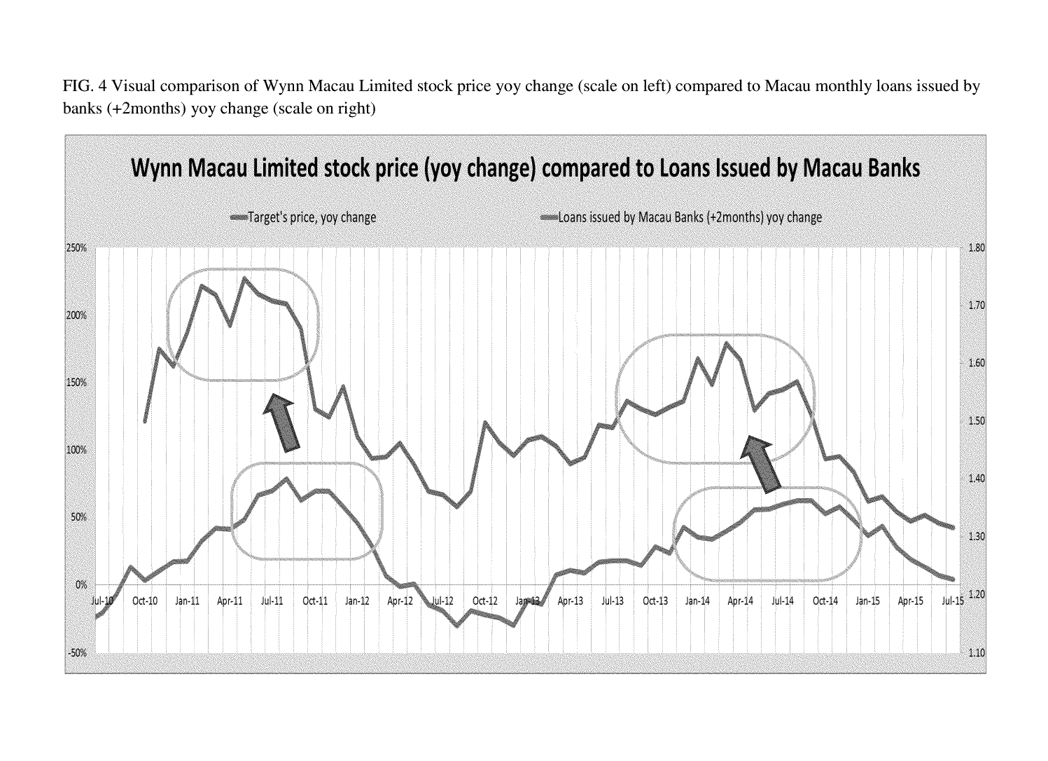

FIG. 5 is a chart for visual comparison of Wynn Macau Limited stock price yoy change (scale on left) compared to China Official Manufacturing PMI (+1 month) (scale on right). The chart shows the economic indicator is a leading indicator, ahead around −1 to 2 month of target's movement.

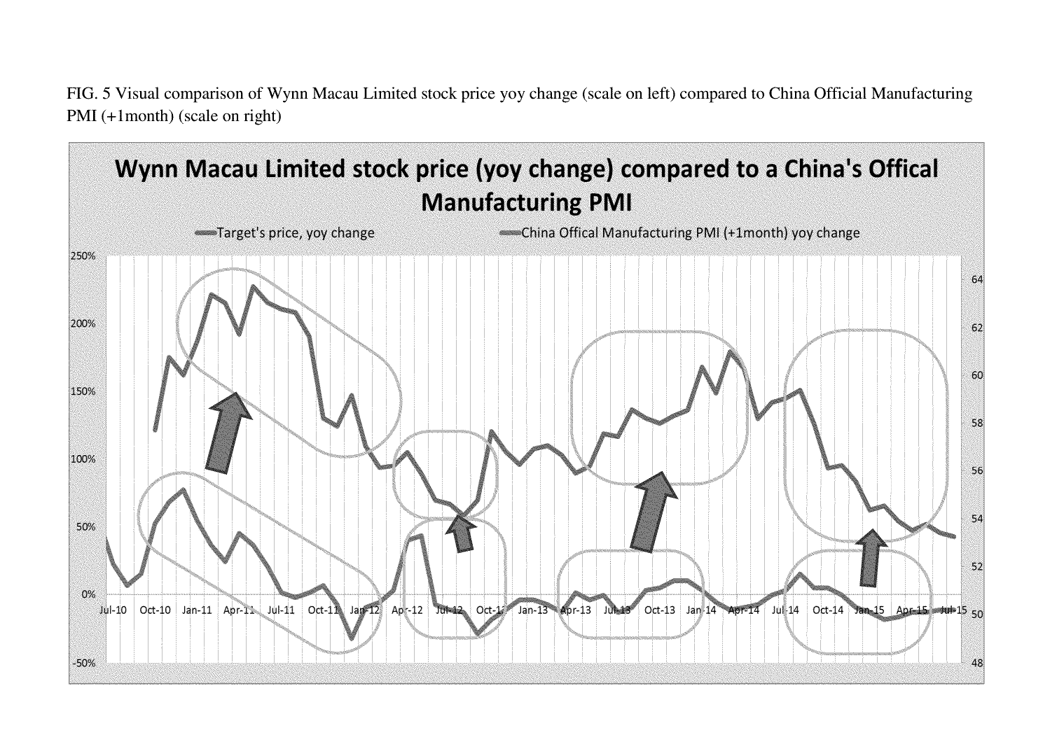

FIG. 6 is a chart for visual comparison of Wynn Macau Limited stock price yoy change (scale on left) compared to China Official Non-Manufacturing PMI (+1 month) (scale on right). The chart shows the economic indicator is a leading indicator, ahead around 1 to 3 month of target's movement. But there are some peak values in the economic indicator that may affect the predictability.

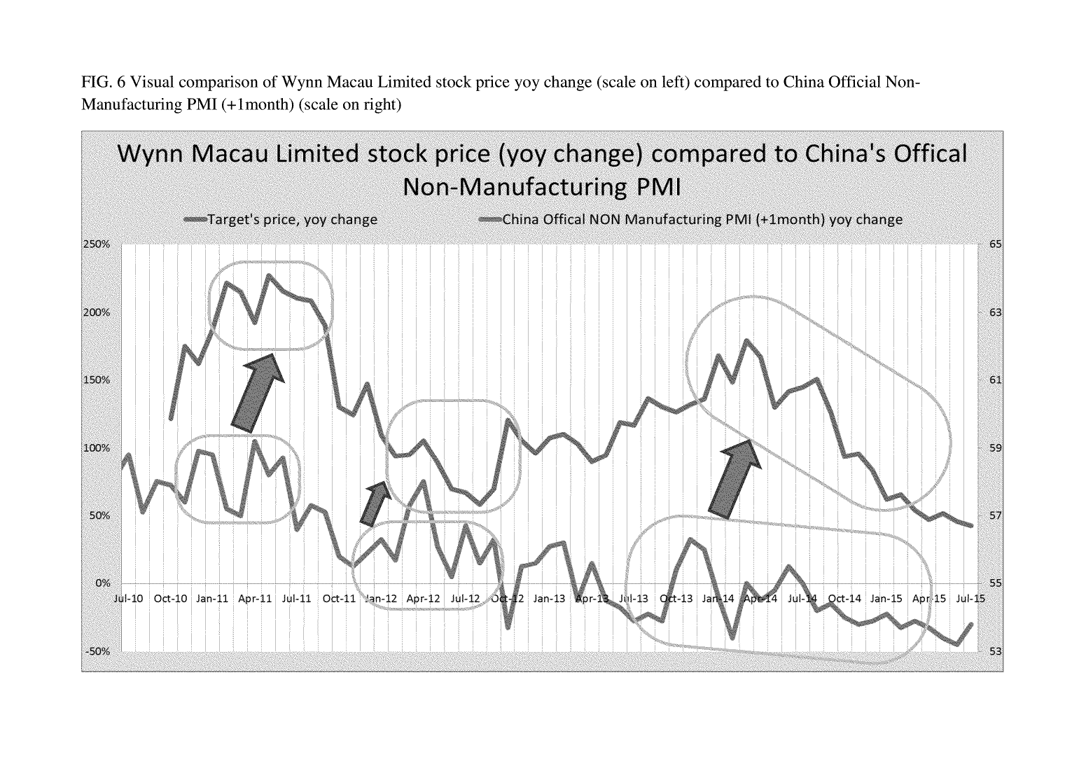

FIG. 7 is a summary of results in Step 2 for round 1 of visual comparison of Wynn Macau Limited's stock price with different economic data.

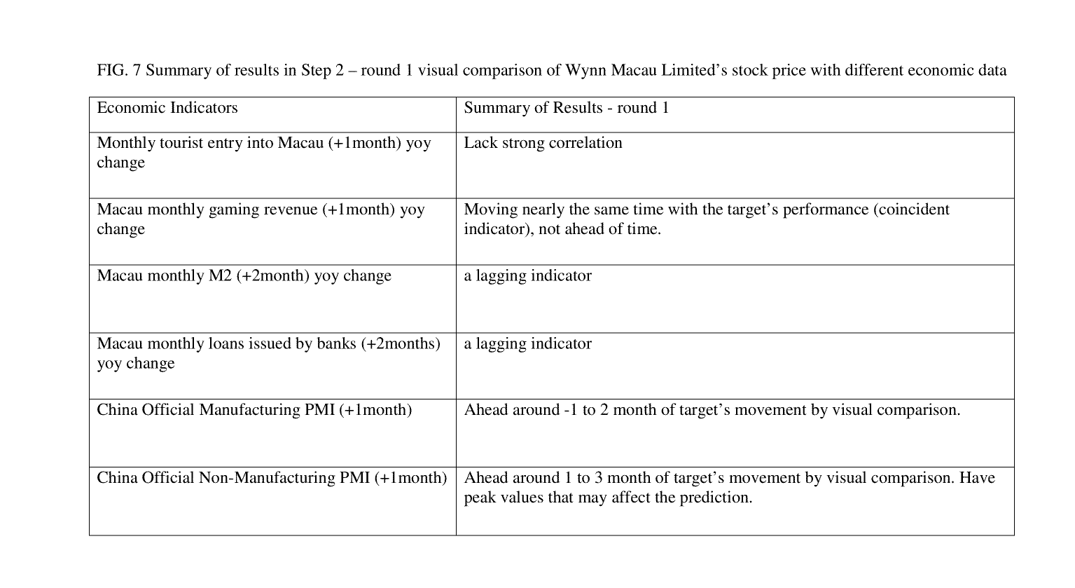

FIG. 8 is a chart for visual comparison of Wynn Macau Limited stock price yoy change compared to Weighted average of China's official manufacturing PMI (weighted 40%), and the China's official non-manufacturing PMI (weighted 60%) (+1 month). This chart shows satisfactory results that the economic indicator, the weighted index, is stably ahead around 0 to 2 month of target's movement.

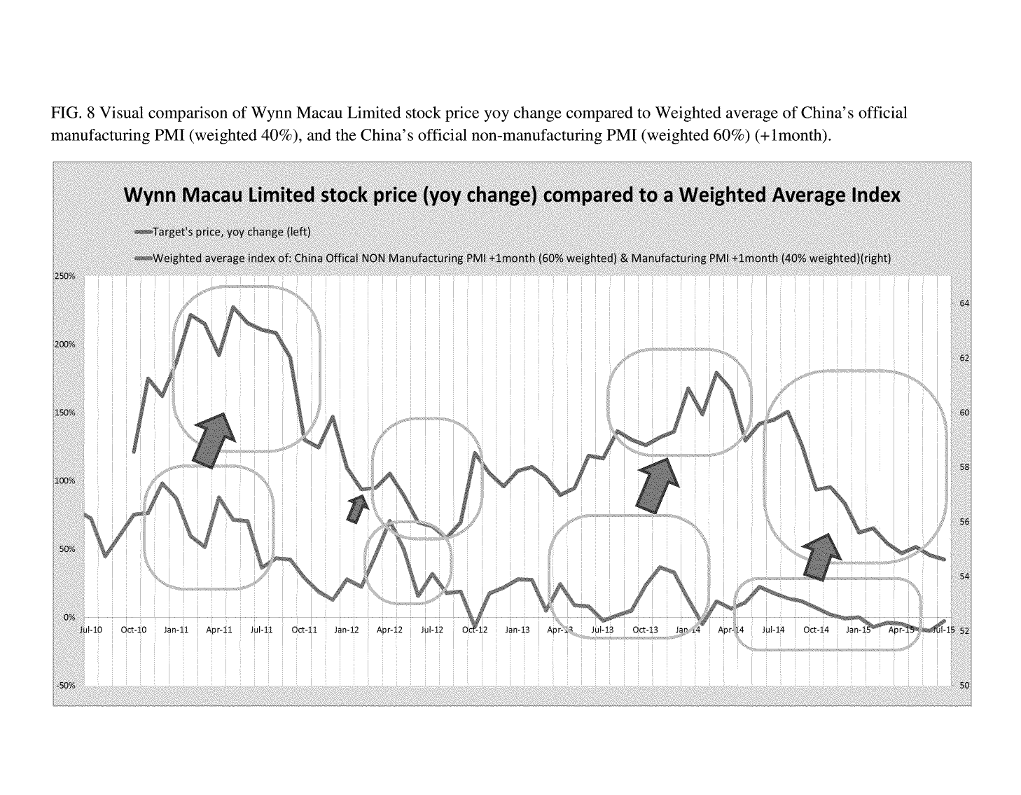

FIG. 9 is a summary of results in Step 2 for round 2.

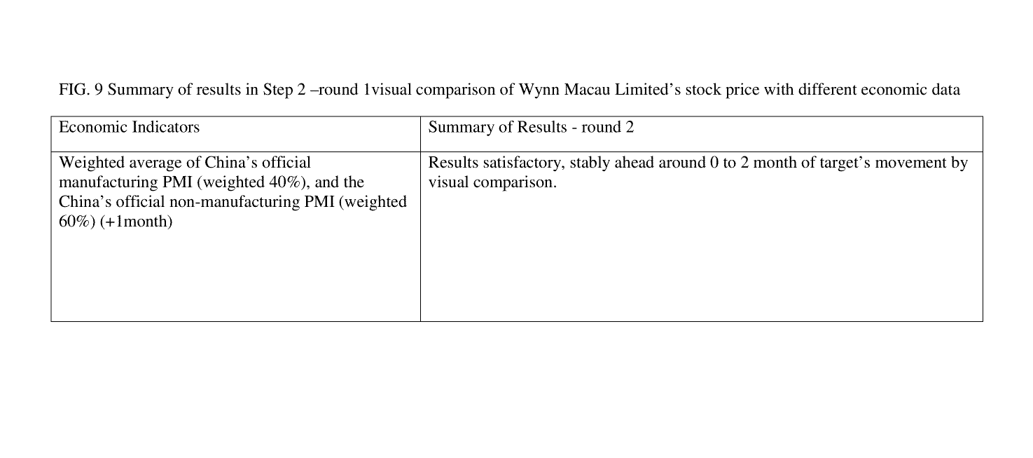

FIG. 10 is a list of backtesting results of the stock price of Wynn Macau Limited with Weighted average of China's official manufacturing PMI (weighted 40%), and the China's official non-manufacturing PMI (weighted 60%) (+1 month). The above average results are highlighted in yellow.

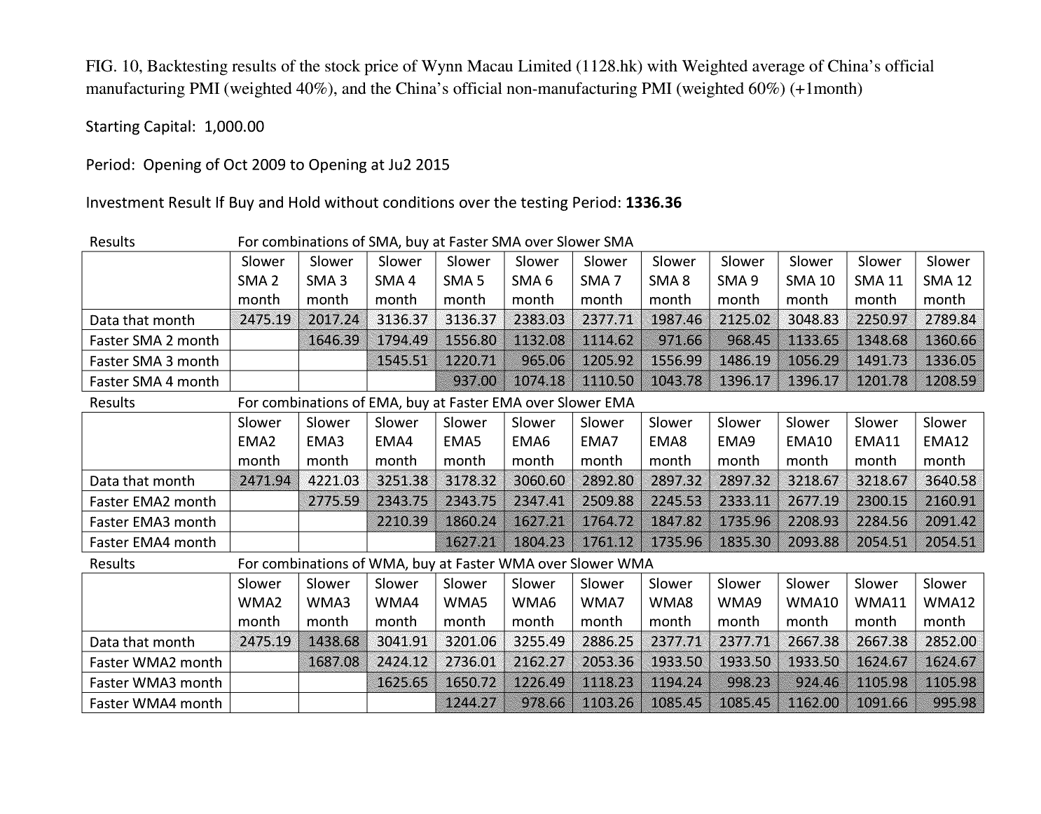

FIG. 11 is a chart comparing the difference in investment result to invest 1000 at Wynn Macau limited with and without applying buying/selling conditions produced by my invention. Blue line show the investment results with normal buy and hold strategy, and red line shows investment results that applied buying/selling conditions produced by my invention.

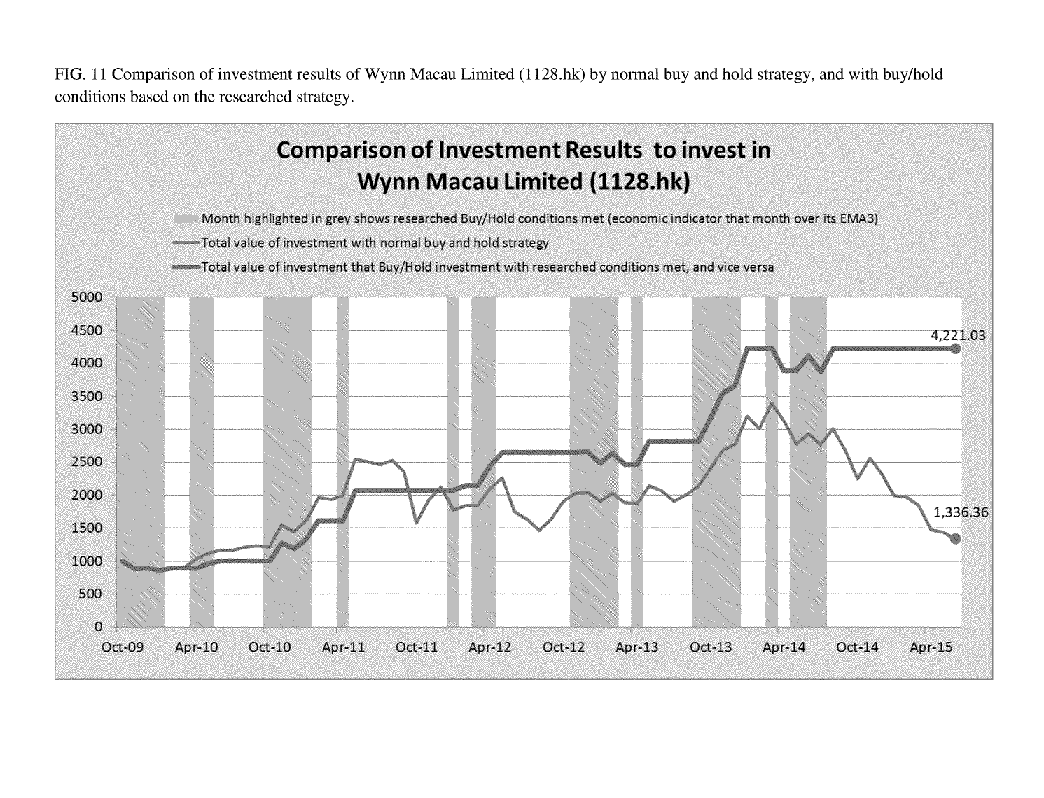

FIG. 12 is a chart for visual comparison of the S&P 500 ETF (SPY.US) price yoy change (scale on left) compared to a weighted average of ISM Manufacturing: New Orders Index+1 month (weighted 20%) and ISM Non-manufacturing: New Orders Index+2 month (weighted 80%).

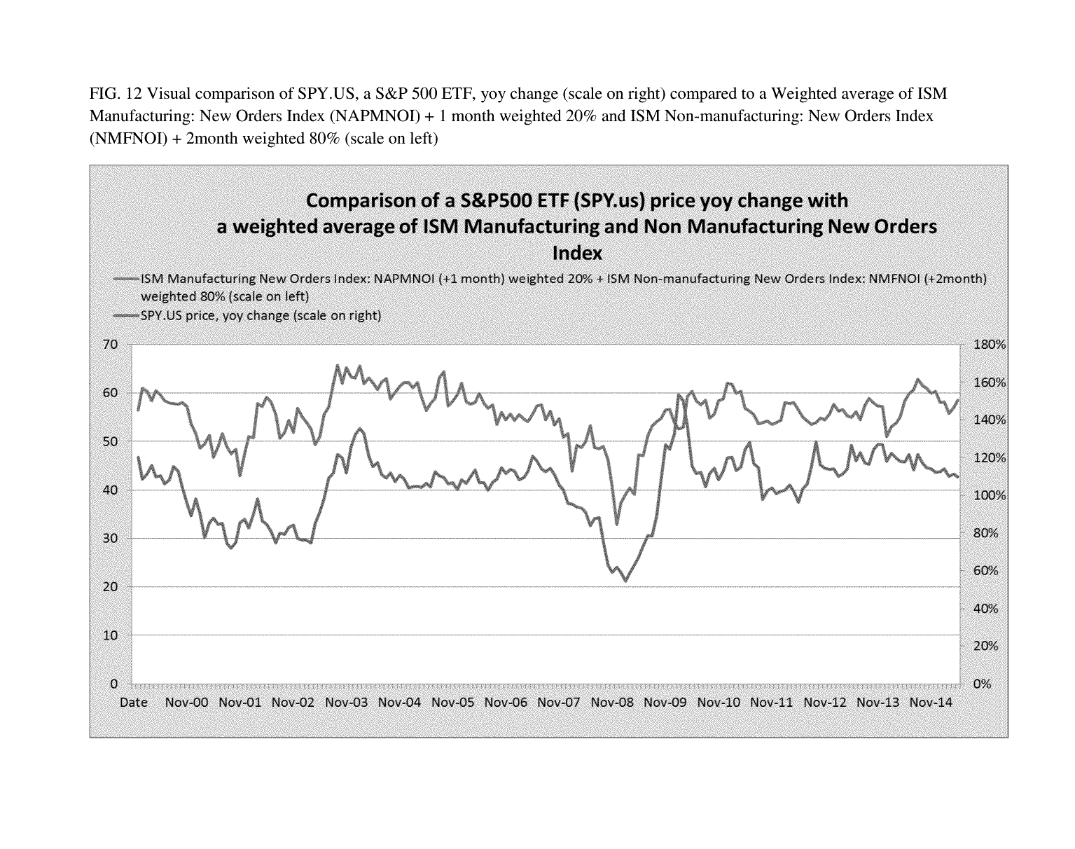

FIG. 13 is a list of backtesting results of the fund price of S&P 500 ETF (SPY.US) with Weighted average of ISM Manufacturing: New Orders Index+1 month (weighted 20%) and ISM Non-manufacturing: New Orders Index+2 month (weighted 80%). The above average results are highlighted in yellow.

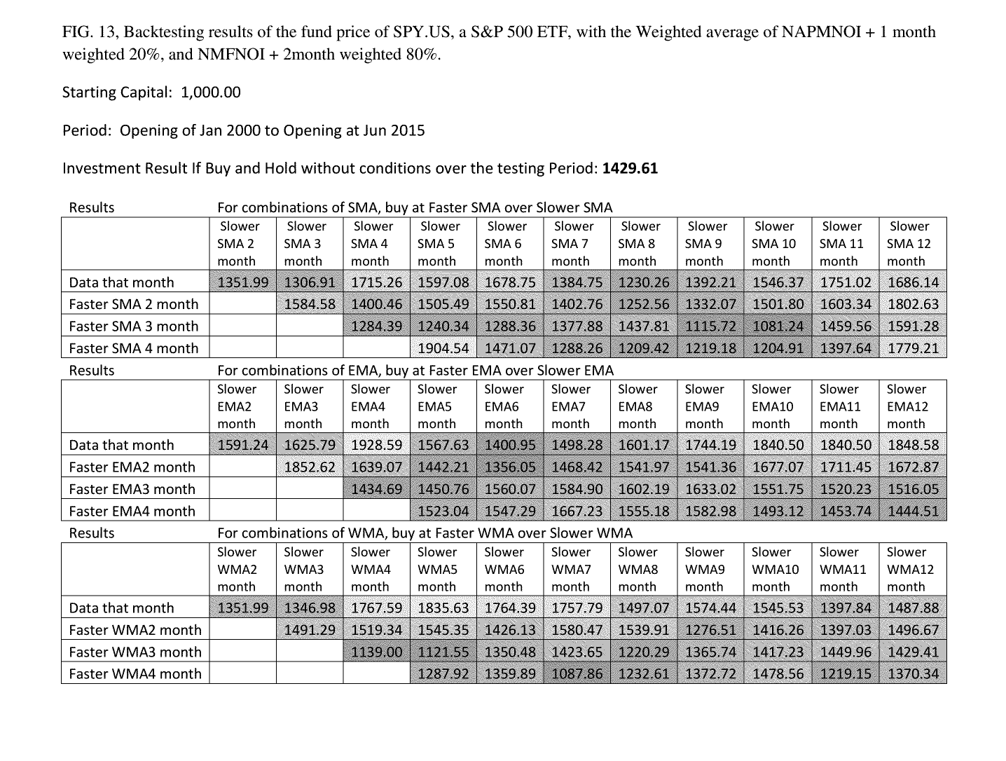

FIG. 14 is a chart comparing the difference in investment result to invest 1000 at SPY.US with and without applying buying/selling conditions produced by my invention. Blue line show the investment results with normal buy and hold strategy, and red line shows investment results that applied buying/selling conditions produced by my invention.

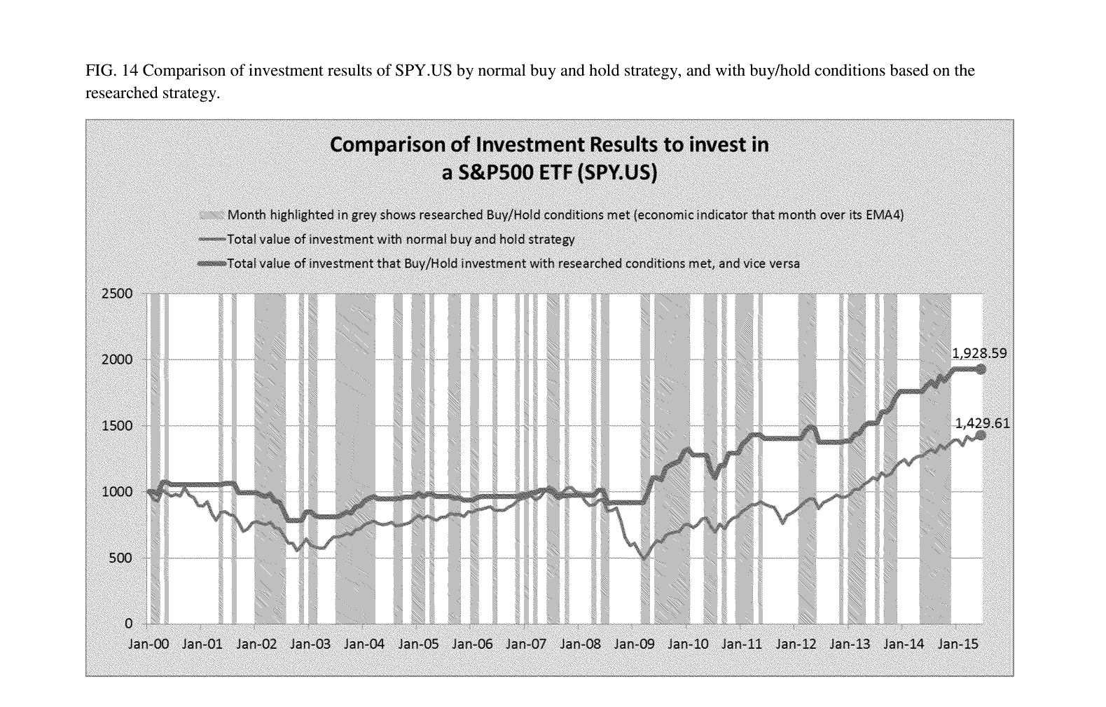

FIG. 15 is a list of backtesting results of the fund price of the TD Ameritrade Holding Corporation with the monthly total trading volumes of companies in S&P500 (+1 month). The above average results are highlighted in yellow.

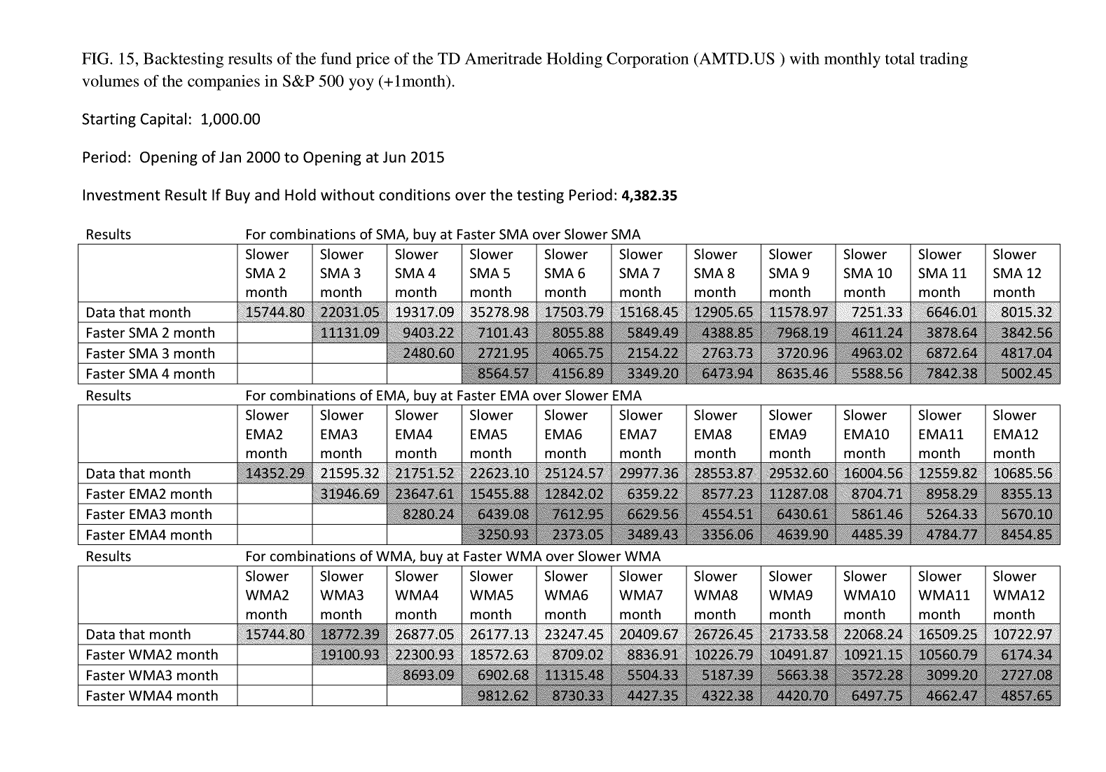

FIG. 16 is a chart comparing the difference in investment result to invest 1000 at TD Ameritrade Holding Corporation with and without applying buying/selling conditions produced by my invention. Blue line show the investment results with normal buy and hold strategy, and red line shows investment results that applied buying/selling conditions produced by my invention.

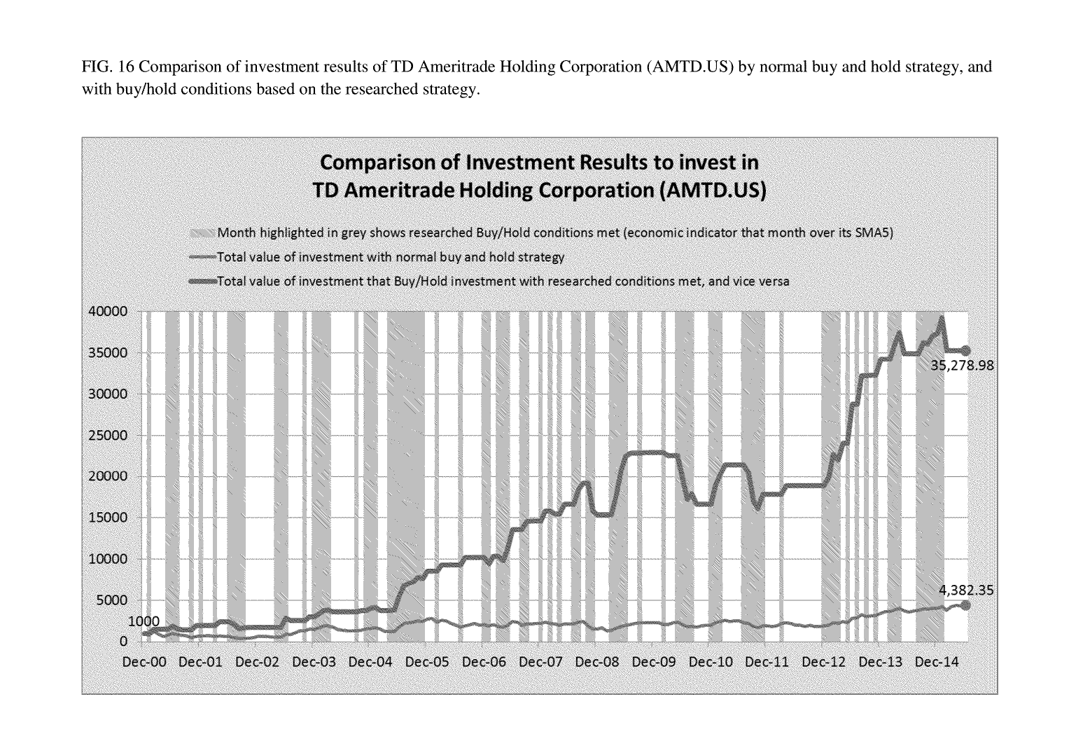

### REFERENCES

Backtesting, no author, Available from: <http://www.investopedia.com/terms/b/backtesting.asp>. [No dated, retrieved on 21 Jul. 2015].
Ellis, Joseph H. (2005), Ahead of the Curve, A Commonsense Guide to Forecasting Business and Market Cycles: Harvard Business Review Press
Moving Average Crossovers, no author, Available from: <http://www.onlinetradingconcepts.com/TechnicalAnalysis/MASimple2.html>. [No dated, retrieved on 21 Jul. 2015].
Murphy, Casey, Moving Averages: Strategies, Available from: <http://www.investopedia.com/university/movingaverage/movingaverages4.asp>. [No dated, retrieved on 21 Jul. 2015].
Twomey, Brian, Simple Vs. Exponential Moving Averages, Available from: <http://www.investopedia.com/articles/trading/10/simple-exponential-moving-averages-compare.asp>. [No dated, retrieved on 21 Jul. 2015].
Wang, Jiayi (2009), Empirical Analysis of China Purchasing Managers Index (PMI) and Shanghai Composite Index (SH): World Science Publisher, United States, Advances in Applied Economics and Finance (AAEF) 615 Vol. 3, No. 4, 2012, ISSN 2167-6348

1. Crossover of 2 (or more) moving average of leading economic indicators can determine buy and sell signals for company's stocks or funds. The researcher can set 2 moving averages on leading economic indicators, the faster moving average that has shorter time intervals, and the slower moving average that has longer time intervals. When the faster moving average moves above the slower moving average, it shows the economic trends are going upwards and signals the investor to buy and hold the stock/fund. On the other hand, when the faster moving average moves below the slower moving average, it signals economic trends are going downwards and signals the investor to sell or exit the stock/fund. Here, leading economic indicators may be an indicator that signals changes of future conditions of the entire economy of that area or only, as small as, a particular business sector. Sometimes, the researcher may also use a weighted average of several economic indicators if it is believed to improve the accuracy of prediction of target's movement.

2. To refine the investment strategy for method stated in claim 1, backtesting is used to test the historic company's stock/fund's price movement with different combinations of faster/slower moving averages and leading economic indicator for the method stated in claim 1.

3. Referring to the moving average of leading economic indicators technique discussed in claim 1, Simple moving average (SMA) of leading economic indicators may be used.

4. Referring to the moving average of leading economic indicators technique discussed in claim 1, Exponential moving average (EMA) of leading economic indicators may be used.

5. Referring to the moving average of leading economic indicators technique discussed in claim 1, Linear weighted moving average (WMA) of leading economic indicators may be used.

6. To apply in use for claim 1 to claim 5, a 4 step method is developed.
Step 1. Define an investment target, which may be company's stock or fund that researcher wants to determine buy and sell signals and form investment strategy.
Step 2. Identify the right leading economic indicators of the target. List a number of possible leading economic indicators that the researcher believes may be able to predict the future movements of the target defined in step 1. The researcher may need to adjust the time lag according to the release time of that economic data that the researcher is able to use.
To confirm whether an economic indicator's movement is leading, or ahead of, the target defined in step 1, the researcher have to test it. The researcher may use computer software or econometric models to test it. Or researcher may make a year over year change basis (yoy) chart for both the target's movement and the economic indicator to make visual comparisons, including time lag discussed above. At this step, the researcher has to confirm at least one, or more than one, economic indicator that is leading, or ahead of, the target's movement. This confirmed leading economic indicator will proceed for the next step. If researcher confirms there are no leading economic indicator of the target in this step, researcher will have to re-do the whole Step 2 again to list, to test, and to identify the right leading economic indicators of the target.
Sometimes, the researcher may also use a weighted average of these economic indicators if it is believed to improve the accuracy of prediction of target's movement.
Step 3. The researcher has to backtest the historic data of investment target (defined in step 1) with 2 moving averages from data of economic indicators with different leading economic indicator confirmed in step 2, at a fixed capital. SMA, EMA, WMA or other moving averages may be used. The backtest will start at a fixed initial capital, lets say $1000, and will compare the investment performance in the test. The researcher has to set 2 moving averages, a faster moving average and a slower moving average for the leading economic indicator confirmed in step 2. The buy and sell signals of the target is generated by the crossing of these moving averages. When the faster moving average moves above the slower moving average, it is seen that the economic trend is upwards. It signals buying or holding the target that period. On the other hand, when the faster moving average moves below the slower moving average, it is seen the economic trend is downwards, and signal selling or not buying the target for that period. Each faster moving average will test against each slower moving average.
In this step, researcher has to backtest the leading economic indicators confirmed in step 2 each at a time. That is, if the researcher confirmed 3 leading economic indicators in step 2, the researcher may need to backtest the target's movement with each of these 3 leading economic indicators.
Step 4: Evaluate the results across different combinations of moving averages and different leading economic indicators. The pair with highest return is the most likely to show best combinations that gives the most accurate buy and sell signals in the test. Or in other words, it is the combination that forms the best investment strategy. However, researcher also need to analyze and check whether it is consistent in:
Avoiding a huge drop, or showing a selling signal before a price collapse.
Capturing a long term rise, showing a buying signal before price is going to rise.
Check also the MA combinations that is next to or close to the one with best results. If those combinations are also showing above average results, researcher may believe investment profit will also be above average in the future.
If the results in this step are satisfactory, researcher may set it as a future investment strategy in investing the target. If the results are not satisfactory, or researcher believe adjustments or modifications are able to improve the results, researcher will need to go back to Step 2 again.
